(19) United States
(12) Patent Application Publication
(10) Pub. No.: US 2025/0368077 A1
(43) Pub. Date: Dec. 4, 2025

(54) SYSTEMS AND METHODS FOR ENHANCING VEHICLE CHARGING EXPERIENCE

(71) Applicant: Ford Global Technologies, LLC, Dearborn, MI (US)

(72) Inventors: Kai Wu, Pittsburgh, PA (US); Najibesadat Sadatijafarkalaei, McKinney, TX (US); Ruthwik Reddy Junuthula, Farmington Hills, MI (US); Dominique Meroux, Ann Arbor, MI (US); Chen Zhang, South Lyon, MI (US); Nicholas Herhusky, Dearborn, MI (US); Colin Turner Lieberman, Ferndale, MI (US); John Eric Rollinger, Troy, MI (US); Scott Steadmon Thompson, Belleville, MI (US)

(73) Assignee: Ford Global Technologies, LLC, Dearborn, MI (US)

(21) Appl. No.: 18/677,666

(22) Filed: May 29, 2024

(51) Int. Cl. B60L 53/62; B60K 35/22; B60K 35/28; B60L 53/65; B60L 53/66; G06F 40/58

(52) U.S. Cl. CPC B60L 53/62; B60K 35/22; B60K 35/28; B60L 53/65; B60L 53/66; B60K 2360/178; G06F 40/58

(57) ABSTRACT

A vehicle charging optimization system including a transceiver and a processor is disclosed. The transceiver may be configured to receive vehicle information from a vehicle or a server. The processor may be configured to determine that the vehicle may be plugged-in to a charger associated with a charging station based on the vehicle information. The processor may further determine that the vehicle did not charge by using the charger based on the vehicle information, and determine that a first type of fault may have occurred in charging the vehicle based on the vehicle information. The processor may further translate a first error code associated with the first type of fault to a first message in natural language, and output the first message on a user device or a vehicle Human-Machine Interface.

### FIELD

The present disclosure relates to systems and methods for enhancing vehicle charging experience for electric vehicles (EVs).

### BACKGROUND

Electric Vehicles (EVs) require regular charging at EV charging stations to ensure optimal vehicle operation. As the EV adoption increases, the number of EVs has increased considerably, resulting in a surge of demand for public charging solutions/stations. While the number of available public charging stations is steadily increasing, the reliability of infrastructure/components in existing charging stations still causes inconvenience to users. For example, there are known instances of users facing inconvenience at the charging stations when one or more chargers are faulty.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts a view of a vehicle located at a charging station in accordance with the present disclosure.

FIG. 2 depicts a view of a vehicle Human-Machine Interface (HMI) displaying an example first message in accordance with the present disclosure.

FIG. 3 depicts a view of a vehicle HMI displaying an example second message in accordance with the present disclosure.

FIG. 4 depicts a flow diagram of an example vehicle charging optimization method in accordance with the present disclosure.

### DETAILED DESCRIPTION

### Overview

The present disclosure describes a vehicle charging optimization system (“system”) that may be configured to enhance a user's vehicle charging experience. Specifically, the system may be configured to determine a charging fault when the user attempts to charge a vehicle at a charging station (e.g., by using a charger), and output a brief description of the fault and possible remedial actions that the user may perform, in an easy-to-understand natural language.

To facilitate the user in vehicle charging, the system may first determine that the vehicle may be located at the charging station and plugged-in to the charger, based on vehicle information obtained from the vehicle and charging station information obtained from a computing system associated with the charging station. In an exemplary aspect, the vehicle information may include charging-related Data Identifiers (DIDs), Diagnostic Trouble Codes (DTCs), Controller Area Network (CAN) signals, and/or the like. Further, the charging station information may include a charging station geolocation, a charging station identifier, a count of AC chargers at the charging station, a count of DC chargers at the charging station, electric vehicle supply equipment (EVSE) status, and/or the like.

Responsive to determining that the vehicle may be plugged-in to the charger, the system may determine whether the vehicle may be charging or not charging based on the vehicle information. The system may determine that a fault may have occurred in charging the vehicle, when the system determines that the vehicle may not be charging by using the charger. Responsive to determining that the vehicle may not be charging, the system may begin to sequentially determine whether a first type of fault may have occurred in charging the vehicle, or a second or third type of fault, and so on, based on the vehicle information. In an exemplary aspect, the first type of fault may be a proximity fault/error, and the second or subsequent types of faults may be a connector fault, an oscillator missing fault, a charger fault, a transport layer security certificate or payment related fault, and/or the like.

Responsive to determining a type of fault associated with vehicle charging, the system may determine an error code (that may be in engineering or technical language) associated with the fault type based on the vehicle information, and then translate the error code into a message in easy-to-understand natural language. In an exemplary aspect, the message may include a brief description of the fault type and a possible remedial action that the user may follow. For example, the message may state, “The connector is improperly seated. Consider disconnecting and reconnecting the connector.” In this manner, the system enables the user to conveniently understand the vehicle charging fault.

The system may be further configured to calculate a vehicle charging assessment score associated with the vehicle based on the fault type experienced by the vehicle and a plurality of additional parameters including, but not limited to, a count of unsuccessful charging attempts for the vehicle at the charging station before the vehicle left the charging station without getting charged, a count of unsuccessful charging attempts for the vehicle at the charging station before a successful charging attempt, an occurrence of a successful charging attempt for the vehicle without any fault at the charging station, and/or the like. The system may aggregate the vehicle charging assessment scores for the vehicle over a predefined time duration, and generate recommendations for the user if the aggregate score is low, to enable enhancement of future vehicle charging experience for the user. The system may similarly calculate a charging station score, and recommend enhancement measures for the charging station when the charging station score may be low. As an example, the system may recommend replacing a specific charger if many vehicles experience fault while charging at the charger. As another example, instead of recommending to replace the charger, the system may send the information associated with the charging errors to a user device associated with a charging point operator to recommend further investigation of the errors. Some of the known errors, e.g., EvseSlaacErr, TlsCertExpired, etc. can be software and/or digital certification related issues/errors, and the charging point operator may fix such errors over-the-air (OTA), without having to replace the charger.

The present disclosure discloses a vehicle charging optimization system that assists a user in deciphering the technical errors/faults associated with public charging, and determining whether the faults are associated with the user's vehicle, the charger, and/or the payment process. The system bridges the gap between complex engineering language and user-friendly communication, thereby empowering the user in conveniently navigating public charging challenges with greater confidence and ease.

These and other advantages of the present disclosure are provided in detail herein.

### ILLUSTRATIVE EMBODIMENTS

The disclosure will be described more fully hereinafter with reference to the accompanying drawings, in which example embodiments of the disclosure are shown, and not intended to be limiting.

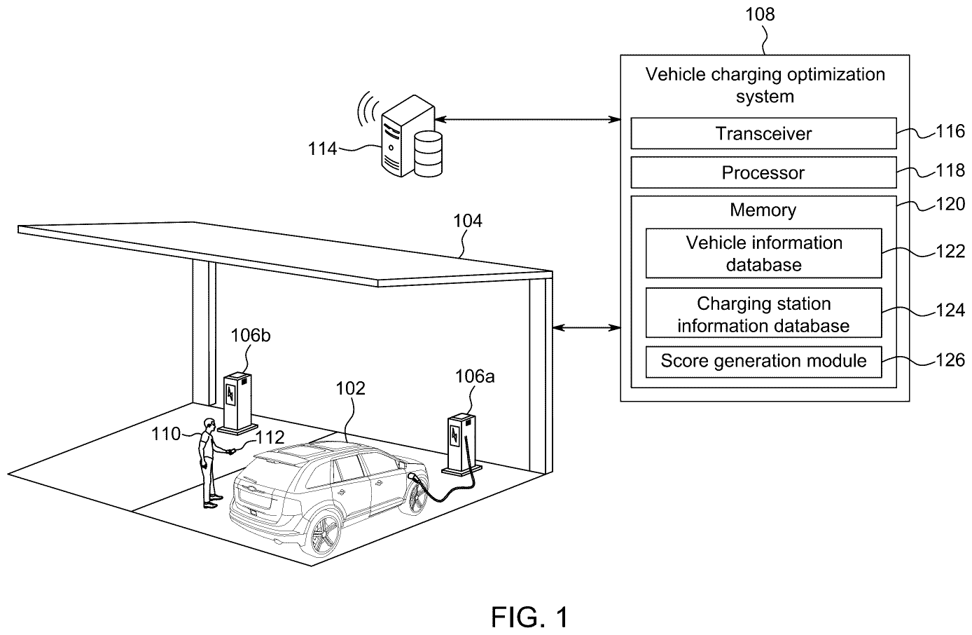

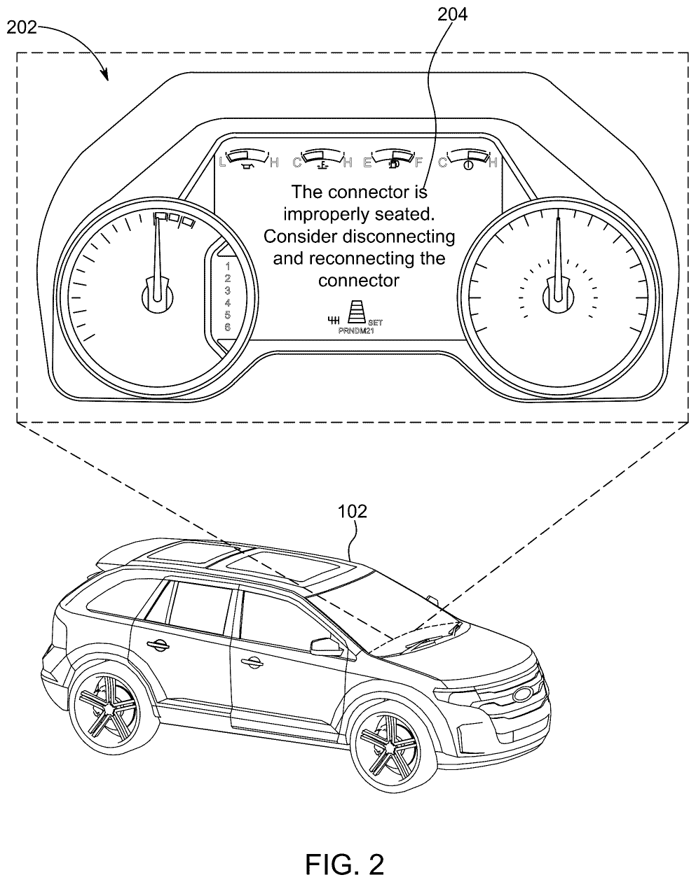

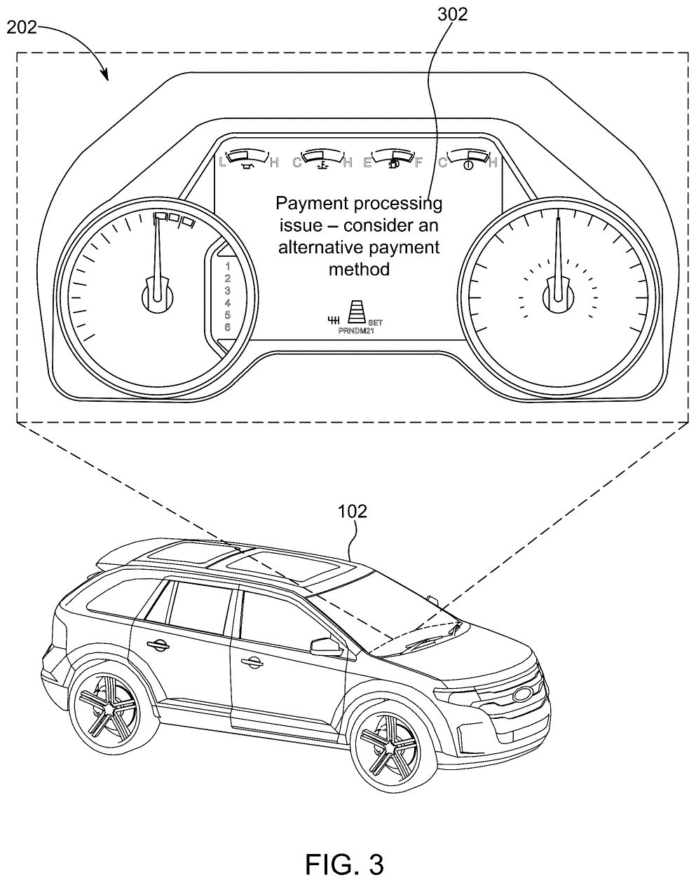

FIG. 1 depicts a view of a vehicle 102 located at a charging station 104 in accordance with the present disclosure. While describing FIG. 1, references will be made to FIGS. 2 and 3.

The vehicle 102 may take the form of any passenger or commercial vehicle such as a car, a work vehicle, a crossover vehicle, a truck, a van, a minivan, a taxi, a bus, etc. The vehicle 102 may be a manually driven vehicle or may be configured to operate in a partially/fully autonomous mode. In an exemplary aspect, the vehicle 102 may be an Electric Vehicle (EV). The vehicle 102 may be located at the charging station 104 to get charged by using one or more chargers 106a, 106b (collectively referred to as charger 106) associated with the charging station 104.

The vehicle 102 may be communicatively coupled with a vehicle charging optimization system 108 (or system 108) via a wireless network. The wireless network, as described herein, illustrates an example communication infrastructure in which the connected devices discussed in various embodiments of this disclosure may communicate. The wireless network may be and/or include the Internet, a private network, public network or other configuration that operates using any one or more known communication protocols such as transmission control protocol/Internet protocol (TCP/IP), Bluetooth®, Bluetooth® Low Energy (BLE), Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The system 108 may be configured to enhance vehicle charging experience for a user 110 associated with the vehicle 102 at the charging station 104 (and a plurality of other charging stations, not shown). Specifically, the system 108 may be configured to determine if the vehicle 102 may not be getting charged by using the charger 106 when the vehicle 102 may be plugged-in to the charger 106, and determine a fault due to which the vehicle 102 may not be getting charged. The system 108 may then output a notification/message in natural language on a user device 112 associated with the user 110 and/or a vehicle Human-Machine Interface (HMI) 202, briefly explaining the fault in user-understandable language (as opposed to highly technical and/or engineering language) and potential remedial actions/steps that the user 110 may follow to rectify the fault. In this manner, the system 108 considerably enhances user's experience of charging the vehicle 102, especially if the vehicle 102 is not getting charged by using the charger 106 and the user 110 is not aware of the reason for it.

The user device 112 may be, for example, a mobile phone, a laptop, a computer, a smartwatch, or any other device with communication capacities. The system 108 may be communicatively coupled, via the wireless network described above, with a plurality of devices/systems including, but not limited to, the vehicle 102, the user device 112, the charger 106, a computing system (not shown) associated with the charging station 104, one or more servers 114 (or server 114), and/or the like. Although FIG. 1 depicts that the system 108 is communicatively coupled with a single vehicle (i.e., the vehicle 102) and a single charging station (i.e., the charging station 104), the system 108 may be configured to communicatively couple with a plurality of vehicles and a plurality of charging stations simultaneously. The system 108 may be hosted on the server 114 (or any other server) or a distributed computing system.

The system 108 may include a plurality of components/units including, but not limited to, a transceiver 116, a processor 118 and a memory 120, which may be communicatively coupled with each other. The transceiver 116 may be configured to transmit/receive information/data to/from external systems and devices via the wireless network described above. For example, the transceiver 116 may be configured to receive (via the wireless network) vehicle information associated with the vehicle 102, directly from the vehicle 102 or via the server 114, when the vehicle 102 may be located at the charging station 104 (or otherwise).

In some aspects, the vehicle information may include, but is not limited to, charging-related Data Identifiers (DIDs), Diagnostic Trouble Codes (DTCs), and/or vehicle's Controller Area Network (CAN) signals, when the vehicle 102 may be located at the charging station 104 and plugged-in to the charger 106. In further aspects, the vehicle information may include, but is not limited to, a vehicle identification number, a vehicle odometer value, a vehicle charging plug status, a charging power mode, a current state of charge (SOC) level, a real-time vehicle geolocation, a voltage request from a vehicle battery to a charger (e.g., the charger 106), a current request from the vehicle battery to the charger, a vehicle arrival time at the charging station 104, a vehicle departure time from the charging station 104, a vehicle real-time charging status, an SOC level at a start of charging, an SOC level at an end of charging, and/or the like. In some aspects, some parts of or all the vehicle information described above may be deduced by the system 108 based on the charging-related DIDs, DTCs and/or CAN signals received by the transceiver 116 from the vehicle 102 or the server 114. In other aspects, some parts of or all the vehicle information described above may be received by the transceiver 116 directly from the vehicle 102.

As another example, the transceiver 116 may be configured to receive (via the wireless network) charging station information associated with the charging station 104 from the computing system associated with the charging station 104 or from the server 114. The charging station information may include information associated with, but not limited to, a charging station geolocation, a charging station identifier, a count of AC chargers at the charging station 104, a count of DC chargers at the charging station 104, electric vehicle supply equipment (EVSE) status, and/or the like. The transceiver 116 may be further configured to transmit (via the wireless network) signals/information/data to the vehicle 102, the server 114, the user device 112, the computing system associated with the charging station 104, and/or the like.

The processor 118 may be in communication with one or more memory devices in communication with the respective computing systems (e.g., the memory 120 and/or one or more external databases not shown in FIG. 1). The processor 118 may utilize the memory 120 to store programs in code and/or to store data for performing aspects in accordance with the disclosure. The memory 120 may be a non-transitory computer-readable storage medium or memory storing a program code that enables the processor 118 to perform operations in accordance with the present disclosure. The memory 120 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

The memory 120 may include a plurality of databases and modules including, but not limited to, a vehicle information database 122, a charging station information database 124, a score generation module 126, and/or the like. The vehicle information database 122 may store the vehicle information, and the charging station information database 124 may store the charging station information described above. The score generation module 126 may be stored in the form of computer-executable instructions, and the processor 118 may be configured and/or programmed to execute the stored computer-executable instructions for performing functions/operations in accordance with the present disclosure. For example, the processor 118 may execute the computer-executable instructions stored in the score generation module 126 to generate/calculate a vehicle charging assessment score and/or a charging station score, which are described later in the description below.

In operation, the transceiver 116 may receive the vehicle information and the charging station information described above, when the user 110 plugs-in the vehicle 102 to the charger 106 or when the vehicle 102 may be located at the charging station 104. The transceiver 116 may transmit the vehicle information and the charging station information to respective memory databases for storage purpose, and/or to the processor 118.

The processor 118 may obtain the vehicle information directly from the transceiver 116 or from the vehicle information database 122. In some aspects, the vehicle information, as obtained from the vehicle 102 or the server 114 may be in raw format, and consequently, responsive to obtaining the “raw” vehicle information, the processor 118 may process or analyze the vehicle information and determine that the vehicle 102 may be plugged-in to the charger 106 based on the vehicle information analysis. Stated another way, the processor 118 may determine that a charging event or a plug event may have started (i.e., the user 110 may have plugged-in the vehicle 102 to the charger 106) based on the charging-related DIDs, DTCs and/or CAN signals obtained from the vehicle 102 or the server 114. The processor 118 may additionally check that the vehicle 102 is located at the charging station 104 by matching the vehicle's geolocation (which may be part of the vehicle information) with the charging station's location (which may be part of the charging station information).

Responsive to determining that the vehicle 102 is plugged-in to the charger 106, the processor 118 may determine whether the vehicle 102 is getting charged/got charged, or did not charge by using the charger 106, based on the vehicle information described above. Stated another way, responsive to determining that the vehicle 102 is plugged-in to the charger 106, the processor 118 may determine whether electric energy/current is flowing from the charger 106 to the vehicle 102.

The processor 118 may determine that a charging fault (“fault”) may have occurred with the vehicle 102 and/or the charger 106 that resulted in the vehicle 102 not getting charged by using the charger 106, when the processor 118 determines that the vehicle 102 is plugged-in to the charger 106 but is not getting charged. Responsive to such determination, the processor 118 may start to sequentially analyze the vehicle information from the charging event start time (as the processor 118 starts to obtain the vehicle information from the vehicle 102), and determine a type of fault that may have occurred in a priority or sequential order of fault checking. For example, the processor 118 may first determine whether a first type of fault has occurred in charging the vehicle 102 based on the analysis of the vehicle information from the charging event start time, and then check whether a second type of fault has occurred in charging the vehicle 102 based on further analysis of the vehicle information if the first type of fault did not occur, and so on. In an exemplary aspect, the first type of fault (i.e., the fault type first checked by the processor 118) may be a proximity fault/error, and the second or subsequent types of faults checked by the processor 118 may include, but is not limited to, a connector fault, an oscillator missing fault, a charger fault, a transport layer security certificate or payment related fault, and/or the like. A person ordinarily skilled in the art may appreciate that as the vehicle's charging-related DIDs, DTCs and/or CAN signals start to get obtained, the proximity error is the first type of error that can be detected, and then as the charging event time passes and further vehicle information is sequentially obtained/available through the “chain of sub-events” for a charging event, it may be possible to determine other types of faults such as the connector fault, the oscillator missing fault, and/or the like. The payment related fault is typically detected/determined towards the end of the chain of sub-events.

Responsive to determining (based on the vehicle information) that a first type of fault may have occurred when the vehicle 102 attempted to charge by using the charger 106, the processor 118 may determine a first error code (or error label) associated with the first type of fault based on the vehicle information (e.g., based on the DTCs). The first error code may be an engineering or technical code associated with the first type of fault, which may be used by vehicle or charging station's engineering teams to easily understand the type of fault that may have occurred in charging the vehicle 102, and perform remedial actions. Typically, such error codes are not easy to understand by a layman, e.g., the user 110. Therefore, to enhance user's vehicle charging experience, responsive to determining the first error code, the processor 118 may fetch/obtain a mapping of a plurality of error codes with a plurality of messages in natural language that may be pre-stored in the memory 120 or the server 114, and correlate the first error code with the mapping. The processor 118 may then translate the first error code to a first message in natural language based on the correlation. The first message may include a brief explanation/description of the first type of fault, and a possible remedial action/step that the user 110 may follow.

The processor 118 may output the first message on the user device 112 and/or the HMI 202, so that the user 110 may view and comprehend the type of fault that may have occurred while charging the vehicle 102 by using the charger 106 in easy-to-understand natural language, and may accordingly perform remedial actions.

In alternative aspects, responsive to determining (based on the vehicle information) that the first type of fault may not have occurred, the processor 118 may sequentially start to check if a second type of fault may have occurred (in a priority or sequential order of fault checking after checking for the first type of fault) based on the vehicle information. Responsive to determining that the second type of fault may have occurred, the processor 118 may determine a second error code associated with the second type of fault based on the vehicle information (e.g., based on the DTCs), and then translate the second error code to a second message in natural language, in the same manner as described above. The processor 118 may then output the second message on the user device 112 and/or the HMI 202, as described above.

Examples of the error codes/labels described above may include, but are not limited to, “EvseResContractCancel” for a type of fault associated with payment, “S3OpenNoOscillator” for a type of fault associated with the connector or oscillator missing fault, “Lock Actuator Fault” for a type of fault associated with the connector or coupler, and/or the like. Further, each of the first message and the second message may include a brief description of the type of fault (i.e., the first and second types) and a recommendation to rectify the type of fault (i.e., the first and second types), determined based on the mapping described above that may be pre-stored in the memory 120 or the server 114. An example message 204, “The connector is improperly seated. Consider disconnecting and reconnecting the connector.”, output on the HMI 202 is depicted in FIG. 2, which may be output by the processor 118 when an oscillator missing fault, a lock actuator fault or any other connector fault may have occurred. Another example message 302, “Payment processing issue-consider an alternative payment method.”, output on the HMI 202 is depicted in FIG. 3, which may be output by the processor 118 when a payment related fault may have occurred.

Since the messages 204, 302 are displayed in easy-to-understand natural language, the user 110 may conveniently perform remedial actions to get the vehicle 102 charged at the charging station 104. In some aspects, the message/recommendation output on the HMI 202 or the user device 112 may also include a recommendation to try another charger (e.g., the charger 106b) or another charging station when, for example, the determined fault type may be associated with a charger fault (e.g., a fault associated with the charger 106 not being able to complete cable check within a predefined time duration, e.g., 40 seconds), or any other pilot fault for which the mapping stored in the memory 120 or the server 114 may not have a recommended solution.

In further aspects, the processor 118 may be configured to “quantify” the vehicle charging experience at the charging station 104, and generate assessment scores for the vehicle 102 and/or the charging station 104, which may be used by the user 110, the charging station operator or firm managing the charging station operation, and/or other entities or firms that manage vehicle maintenance for a plurality of vehicles and/or charging station maintenance for a plurality of charging stations. In an exemplary aspect, the processor 118 may execute the instructions stored in the score generation module 126 to generate/calculate a vehicle charging assessment score associated with the vehicle 102 for the charging event at the charging station 104, based on a determination of whether the first type of fault or the second type of fault (or any other type of fault) occurred in charging the vehicle 102 at the charging station 104 and a plurality of first parameters. The processor 118 may calculate the vehicle charging assessment score at the end of the charging event (i.e., when the processor 118 has received vehicle information for the entire charging event, or when the vehicle 102 leaves the charging station 104), or may continuously calculate and update the vehicle charging assessment score as the vehicle 102 may be getting charged or attempting to get charged at the charging station 104 (e.g., by using the charger 106a or the charger 106b).

In some aspects, the vehicle charging assessment score may be indicative of the vehicle charging experience for the user 110/vehicle 102 at the charging station 104. The first parameters described above may be, for example, a count of unsuccessful charging attempts for the vehicle 102 at the charging station 104 associated with the charging event before the vehicle 102 left the charging station 104 without getting charged, a count of unsuccessful charging attempts for the vehicle 102 at the charging station 104 before a successful charging attempt associated with the charging event, an occurrence of a successful charging attempt for the vehicle 102 without any fault at the charging station 104 associated with the charging event, and/or the like.

Responsive to calculating the vehicle charging assessment score associated with the vehicle 102 for the charging event as described above, the processor 118 may transmit, via the transceiver 116, the vehicle charging assessment score to the server 114 for storage purpose, or may store the vehicle charging assessment score in the memory 120. The processor 118 may be further configured to aggregate or calculate an aggregate vehicle charging assessment score for the vehicle 102 based on the vehicle charging assessment score described above, and a plurality of similar historical vehicle charging assessment scores associated with the vehicle 102. In an exemplary aspect, the processor 118 may calculate the aggregate vehicle charging assessment score by using an Exponential Weighted Moving Average (EWMA) algorithm, which may calculate weighted average based on a plurality of parameters including, but not limited to, a time duration (e.g., 10 days, 15 days, 30 days, 90 days, 180 days, etc.) for which the vehicle charging assessment scores are captured and aggregated, a time spent by the vehicle 102 at each charging event, individual vehicle assessment scores, and/or the like.

In some aspects, in addition to calculating the aggregate vehicle charging assessment score for the vehicle 102 as described above, the processor 118 may calculate a confidence level score associated with the aggregate vehicle charging assessment score based on a plurality of second parameters and the charging station information (e.g., the charging station location, identifier, etc.) associated with each charging station where the vehicle 102 may have attempted the charging events. The examples of the charging station information are already described above. The second parameters may be, for example, a count of visits of the vehicle 102 to the charging station over a predefined time duration (e.g., the time duration described above, for which the aggregate vehicle charging assessment score is calculated), a time since last visit of the vehicle 102 to the charging station, a vehicle charging assessment score variance per vehicle of a plurality of vehicles visiting the charging station over the predefined time duration, and/or the like.

Responsive to calculating the aggregate vehicle charging assessment score for the vehicle 102 and the confidence level score, the processor 118 may output the aggregate vehicle charging assessment score and the confidence level score to the user device 112, the HMI 202, and/or the server 114, so that the user 110 and/or the firm managing the charging station and/or vehicle maintenance may view the scores and accordingly perform remedial actions for future enhancements (e.g., if the vehicle charging assessment score may be less than a predefined threshold value).

In further aspects, the processor 118 may itself determine that the aggregate vehicle charging assessment score may be low (i.e., less than the predefined threshold value), and recommend remedial actions. In this case, responsive to determining that the aggregate vehicle charging assessment score may be low, the processor 118 may generate a recommended remedial action for the vehicle 102 based on a plurality of types of faults experienced by the vehicle 102 while charging at different charging stations over a predefined time duration. For example, the processor 118 may generate a recommended remedial action for the vehicle 102 indicating that the vehicle 102 should not get charged at the charger 106 and instead charge at any other charger or charging station, when the processor 118 determines that the vehicle charging assessment score for the vehicle 102 while charging using the charger 106 is low. As another example, the processor 118 may generate a recommended remedial action for the vehicle 102 indicating that the vehicle connector may require repair, if the processor 118 determines that the vehicle charging assessment score for the vehicle 102 while charging at most charging stations/chargers is low, and vehicle connector fault is detected in most cases.

Responsive to generating the recommended remedial action described above, the processor 118 may output the recommended remedial action on the user device 112 and/or the HMI 202, so that the user 110 may follow the recommendation and not use the charger 106 in the future or repair the vehicle connector, thereby considerably enhancing user's experience of vehicle charging.

In some aspects, the processor 118 may additionally determine/generate the recommended remedial action based on historical information associated with the vehicle 102 and/or the charging station 104 that may be pre-stored in the memory 120 and/or the server 114. This may include information associated with past vehicle charge faults, as well as vehicle and charging station service and/or software update history.

Although the description above is associated with the processor 118 calculating the vehicle charging assessment score for the vehicle 102, in additional aspects, the processor 118 may also similarly calculate a charging station score associated with the charging station 104, based on the plurality of first parameters, the second parameters and the charging station information described above. Furthermore, the processor 118 may recommend similar remedial actions as described above, when the calculated charging station score may be low.

The vehicle 102 and/or the system 108 implement and/or perform operations, as described here in the present disclosure, in accordance with the owner manual and safety guidelines. In addition, any action taken by the user 110 based on the notifications/recommendations provided by the vehicle 102 and/or the system 108 should comply with all the rules specific to the location and operation of the vehicle 102 (e.g., Federal, state, country, city, etc.). The notifications/recommendations, as provided by the vehicle 102 and/or the system 108, should be treated as suggestions and only followed according to any rules specific to the location and operation of the vehicle 102.

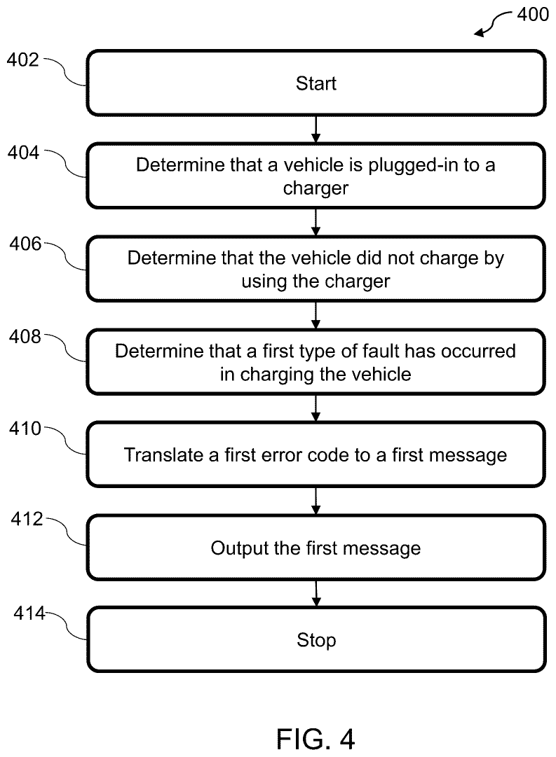

FIG. 4 depicts a flow diagram of an example vehicle charging optimization method 400 in accordance with the present disclosure. FIG. 4 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 400 starts at step 402. At step 404, the method 400 may include determining, by the processor 118, that the vehicle 102 is plugged in to the charger 106 based on the vehicle information. At step 406, the method 400 may include determining, by the processor 118, that the vehicle 102 did not charge by using the charger 106 based on the vehicle information, responsive to determining that the vehicle 102 is plugged in.

At step 408, the method 400 may include determining, by the processor 118, that the first type of fault may have occurred in charging the vehicle 102 based on the vehicle information, responsive to determining that the vehicle 102 did not charge. At step 410, the method 400 may include translating, by the processor 118, the first error code associated with the first type of fault to the first message in natural language. At step 412, the method 400 may include outputting, by the processor 118, the first message on the user device 112 and/or the HMI 202.

At step 414, the method 400 may end.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A vehicle charging optimization system comprising:
a transceiver configured to receive a vehicle information from at least one of a vehicle or a server;
a processor communicatively coupled with the transceiver, wherein the processor is configured to:
determine that the vehicle is plugged in to a charger associated with a charging station based on the vehicle information;
determine that the vehicle did not charge by using the charger based on the vehicle information, responsive to determining that the vehicle is plugged in;
determine that a first type of fault has occurred in charging the vehicle based on the vehicle information, responsive to determining that the vehicle did not charge;
translate a first error code associated with the first type of fault to a first message in natural language; and
output the first message on a user device or a vehicle Human-Machine Interface (HMI).

2. The vehicle charging optimization system of claim 1 further comprising a memory configured to store a mapping of a plurality of error codes with a plurality of messages in natural language, wherein the processor is further configured to:
determine the first error code based on the vehicle information, responsive to determining that the first type of fault has occurred;
obtain the mapping from the memory responsive to determining the first error code; and
translate the first error code to the first message based on the mapping.

3. The vehicle charging optimization system of claim 1, wherein the first type of fault is a proximity fault.

4. The vehicle charging optimization system of claim 1, wherein the vehicle information comprises at least one of charging-related Data Identifiers (DIDs), Diagnostic Trouble Codes (DTCs), or Controller Area Network (CAN) signals.

5. The vehicle charging optimization system of claim 4, wherein the vehicle information further comprises at least one of a vehicle identification number, a vehicle odometer value, a vehicle charging plug status, a charging power mode, a current state of charge (SOC) level, a real-time vehicle geolocation, a voltage request from a vehicle battery to the charger, a current request from the vehicle battery to the charger, a vehicle arrival time at the charging station, a vehicle departure time from the charging station, a vehicle real-time charging status, an SOC level at a start of charging, or an SOC level at an end of charging.

6. The vehicle charging optimization system of claim 1, wherein the processor is further configured to:
determine that the first type of fault did not occur based on the vehicle information, responsive to determining that the vehicle did not charge;
determine that a second type of fault has occurred in charging the vehicle based on the vehicle information, responsive to determining that the first type of fault did not occur;
translate a second error code associated with the second type of fault to a second message in natural language; and
output the second message on the user device or the vehicle HMI.

7. The vehicle charging optimization system of claim 6, wherein the second type of fault is at least one of a connector fault, an oscillator missing fault, a charger fault, or a transport layer security certificate or payment related fault.

8. The vehicle charging optimization system of claim 6, wherein the transceiver is further configured to receive a charging station information associated with the charging station, and wherein the processor is further configured to calculate a vehicle charging assessment score associated with the vehicle for a charging event based on a determination of whether the first type of fault or the second type of fault occurred in charging the vehicle and a plurality of first parameters.

9. The vehicle charging optimization system of claim 8, wherein the plurality of first parameters comprises at least one of a count of unsuccessful charging attempts for the vehicle at the charging station associated with the charging event, a count of unsuccessful charging attempts for the vehicle at the charging station before a successful charging attempt associated with the charging event, or an occurrence of a successful charging attempt for the vehicle without any fault at the charging station associated with the charging event.

10. The vehicle charging optimization system of claim 8, wherein the processor is further configured to:
calculate an aggregate vehicle charging assessment score based on the vehicle charging assessment score and a plurality of historical vehicle charging assessment scores associated with the vehicle;
calculate a confidence level score associated with the aggregate vehicle charging assessment score based on a plurality of second parameters and the charging station information; and
output the aggregate vehicle charging assessment score and the confidence level score on at least one of the user device, the vehicle HMI or the server.

11. The vehicle charging optimization system of claim 10, wherein the processor is further configured to:
determine that the aggregate vehicle charging assessment score is less than a predefined threshold;
generate a recommended remedial action for the vehicle based on a plurality of types of faults experienced by the vehicle while charging over a predefined time duration, responsive to determining that the aggregate vehicle charging assessment score is less than the predefined threshold; and
output the recommended remedial action on at least one of the user device or the vehicle HMI.

12. The vehicle charging optimization system of claim 10, wherein the plurality of second parameters comprises at least one of a count of visits of the vehicle to the charging station over a predefined time duration, a time since last visit of the vehicle to the charging station, or a vehicle charging assessment score variance per vehicle of a plurality of vehicles visiting the charging station over the predefined time duration.

13. The vehicle charging optimization system of claim 8, wherein the charging station information comprises at least one of a charging station geolocation, a charging station identifier, a count of AC chargers at the charging station, electric vehicle supply equipment (EVSE) status, or a count of DC chargers at the charging station.

14. The vehicle charging optimization system of claim 1, wherein the first message comprises a recommendation to rectify the first type of fault.

15. A vehicle charging optimization method comprising:
determining, by a processor, that a vehicle is plugged in to a charger associated with a charging station based on a vehicle information obtained from at least one of a vehicle or a server;
determining, by the processor, that the vehicle did not charge by using the charger based on the vehicle information, responsive to determining that the vehicle is plugged in;
determining, by the processor, that a first type of fault has occurred in charging the vehicle based on the vehicle information, responsive to determining that the vehicle did not charge;
translating, by the processor, a first error code associated with the first type of fault to a first message in natural language; and
outputting, by the processor, the first message on a user device or a vehicle Human-Machine Interface (HMI).

16. The vehicle charging optimization method of claim 15, wherein the vehicle information comprises at least one of charging-related Data Identifiers (DIDs), Diagnostic Trouble Codes (DTCs), or Controller Area Network (CAN) signals.

17. The vehicle charging optimization method of claim 15 further comprising:
determining that the first type of fault did not occur based on the vehicle information, responsive to determining that the vehicle did not charge;
determining that a second type of fault has occurred in charging the vehicle based on the vehicle information, responsive to determining that the first type of fault did not occur;
translating a second error code associated with the second type of fault to a second message in natural language; and
outputting the second message on the user device or the vehicle HMI.

18. The vehicle charging optimization method of claim 17, wherein the first type of fault is a proximity fault, and wherein the second type of fault is at least one of a connector fault, an oscillator missing fault, a charger fault, or a transport layer security certificate or payment related fault.

19. The vehicle charging optimization method of claim 15, wherein the first message comprises a recommendation to rectify the first type of fault.

20. A non-transitory computer-readable storage medium having instructions stored thereupon which, when executed by a processor, cause the processor to:
determine that a vehicle is plugged in to a charger associated with a charging station based on a vehicle information obtained from at least one of a vehicle or a server;
determine that the vehicle did not charge by using the charger based on the vehicle information, responsive to determining that the vehicle is plugged in;
determine that a first type of fault has occurred in charging the vehicle based on the vehicle information, responsive to determining that the vehicle did not charge;
translate a first error code associated with the first type of fault to a first message in natural language; and
output the first message on a user device or a vehicle Human-Machine Interface (HMI).
